(19) United States
(12) Patent Application Publication
(10) Pub. No.: US 2024/0338503 A1
(43) Pub. Date: Oct. 10, 2024

(54) Real-Time Height Field Generation of a Multi-Phase Fluid and Granular Substance Mixture

(71) Applicant: TENCENT AMERICA LLC, Palo Alto, CA (US)

(72) Inventors: Kui WU, Irvine, CA (US); Zherong PAN, Bellevue, WA (US); Xifeng GAO, Bellevue, WA (US)

(73) Assignee: TENCENT AMERICA LLC, Palo Alto, CA (US)

(21) Appl. No.: 18/192,127

(22) Filed: Mar. 29, 2023

(51) Int. Cl. G06F 30/28

(52) U.S. Cl. CPC G06F 30/28; G06F 2113/08

(57) ABSTRACT

An example real-time simulation framework for a fluid and granular substance mixture is disclosed. Such a framework may be based on modeling height fields and horizontal velocities of different material phases, which in the context of a water-sand system, may include sand, water, and mixed water. The framework achieves a trade-off between simulation fidelity and performance, providing real-time computation for interactive applications. The example framework formulates the external frictional force and elastoplastic internal force of sand based on horizontal grid and further handles the water/sand coupling via diffusion and momentum exchange. The time updates for the simulation is efficiently performed using a semi-implicit operator splitting discretization scheme and an asynchronous scheme for the fluid and the granular substance.

### FIELD OF THE INVENTION

This disclosure generally relates to computer-generated graphics and is particularly directed to a real-time simulation of flow dynamics of a multi-phase mixture of a fluid and a granular substance.

### BACKGROUND OF THE INVENTION

Computer simulation of flow dynamics of a mixture of heterogeneous materials in forms of fluid and granular substance, such as water and sand, usually involves complex modeling, excessive computation resources, and large memory space utilization. In applications where real-time or near-real time simulation is needed in an environment limited by computation and networking resources, a simplistic yet realistic physical model in combination with an efficient computation procedure may become critical. Such applications include but are not limited to real-time generation of graphics in video games, virtual reality, augmented reality, an other immersive interactive applications.

### SUMMARY OF THE INVENTION

This disclosure relates to computer-generated graphics and is particularly directed to a real-time simulation of flow dynamics of large bodies of heterogeneous materials, such as multi-phase mixtures of a fluid and a granular substance including but not limited to a water and sand. In the disclosure below, the terms “water” and “sand’ may be understood as being used to broadly refer to any fluid and granular substance, respectively.

Specifically in this disclosure, dynamics of such a water-sand system is modeled as having multiple layers with distinct phases over a predefined terrain. The multiple phases, for example, may include a water phase, a mixed water-sand phase, and the solid sand phase. The terrain may be divided into a plurality of grid-like horizontal cells. Each of the horizontal cells may be associated with horizontal coordinates x and y. The dynamics of each of the multiple phases and the water-sand mixture may be tracked in each of the plurality of horizontal cells using separate but coupled physical models for the water and sand based on mass conservation of water and sand from cell to cell, and driven by various intra-cell and inter-cell forces between the various phases as well as external forces such gravity and friction from the terrain. One or more of the multiple phases may be present in the vertical direction in each horizontal cell, forming stacked columns or layers of different phases. The depth of a layer (or a phase) as a function of the horizontal cells may be referred to as a height field for that phase. Each of the layers and or phases may be associated with a corresponding height field. The physical model is further based on a shallow-water assumption such that vertical velocities in the water-sand system is considered negligible. As such, each of the layer or column of different phases in each horizontal cell may also be described by a horizontal velocity representing its flow in addition to its depth (height). The velocity of a layer of all cells thus form a velocity field of that layer. The height fields and velocity fields of each of the phases may be used as a basis for generating a graphical representation of the flow dynamics of the water-sand system. The physical model includes depth integrated governing equations that are capable of modeling an elastoplastic behavior of wet sand, as well as sand-water flow and mixing phenomena such as mass conservation, friction, diffusion, saturation, and momentum exchange. These phenomena are expressed as various continuity and force operators (representing accelerations). In performing time-evolution dynamics of the water-sand system in each of a sequence of time steps, a splitting of the various operators is adopted, providing a stable and computation efficient time integration in real-time and under moderate time step sizes. In addition, the time updates for the water phases and the sand phase may be performed in an asynchronous manner. In particular, the time update of the sand phase may be performed more frequently than the time update for the water. In such a manner, efficiency and of the simulation may be improved without much degradation of simulation performance. The disclosed approach may run at real-time frame rates and achieves a desirable trade-off between fidelity and performance for immersive experience for interactive applications.

In an example implementation, a method is disclosed for for computer generation of a time evolution of horizontal heights field involving a fluid substance and a granular substance. The method may include dividing the horizontal height fields at each horizontal cell of a plurality of horizontal cells over a predefined static terrain into one or more of a fluid layer of the fluid substance, a mixed layer of a mixture of the fluid substance and the granular substance, and a solid layer of the granular substance; modeling the time evolution of at least one set of a first depth and a first horizontal velocity of the fluid layer, a second depth and a second horizontal velocity of the fluid substance in the mixed layer, and a third depth and a third horizontal velocity of the granular substance in each horizontal cell under a shallow-fluid approximation, using a plurality of mass and momentum conservation operators, in a plurality of sequential time steps, and adopting a splitting discretization scheme with respect to the plurality of mass and momentum conservation operators, the first depth, the second depth, and the third depth forming the horizontal height fields; and generating a visual representation of the time evolution of at least one of the horizontal height fields, the first horizontal velocity, the second horizontal velocity, and the third horizontal velocity for display on a graphical user interface.

In the example implementation above, modeling the time evolution of at least one set of the first depth and the first horizontal velocity, the second depth and the second horizontal velocity, and the third depth and the third horizontal velocity in each horizontal cell may include: modeling the first depth and the first horizontal velocity of the fluid layer in each horizontal cell with a first set of dynamic equations based on a continuity operator and a first momentum exchange force operator; modeling the second depth and the second horizontal velocity of the fluid substance in the mixed layer in each horizontal cell with a second set of dynamic equations based on the continuity operator, a diffusion mass transfer operator, a gravity force operator, a diffusion force operator, and a second momentum exchange force operator; modeling the third depth and the third horizontal velocity of the granular substance with a third set of dynamic equations based on the continuity operator, the gravity force operator, an elastoplastic force operator, a third momentum exchange force operator, and a friction force operator due to the predefined static terrain; and generating the time evolution of at least one set of the first depth and the first horizontal velocity, the second depth and the second horizontal velocity, and the third depth and the third horizontal velocity at each of the plurality of sequential time steps based on the first set of dynamic equations, the second set of dynamic equations, and the third set of dynamic equations, using the splitting discretization scheme with respect to at least two of the continuity operator, the diffusion mass transfer operator, the gravity force operator, the diffusion force operator, the momentum exchange force operators, the elastoplastic force operator, and the friction force operator at each sequential time step.

In any one of the example implementations above, the splitting discretization scheme at each time step for updating the first depth, the first horizontal velocity, the second depth, and the second horizontal velocity may include sequentially performing: updating the first depth and the first horizontal velocity using the first set of dynamic equations and accounting only for the diffusion mass transfer operator and the diffusion force operator; integrating the first depth and the second depth respectively using the first set of dynamic equations and the second set of dynamic equations, and accounting only for the continuity operator; and integrating the first horizontal velocity and the second horizontal velocity respectively using the first set of dynamic equations and the second set of dynamic equations, and accounting only for the gravity force operator and the second momentum exchange force operator.

In any one of the example implementations above, the splitting discretization scheme at each of the plurality of sequential time steps for updating the third depth and the third horizontal velocity may include iteratively performing the following in one or more sub time steps: updating the third depth using the third set of dynamic equations and accounting only for the continuity operator; performing a deformation gradient evolution of the third horizontal velocity using the third set of dynamic equations and accounting only for the elastoplastic force operator; integrating the third horizontal velocity using the third set of dynamic equations and accounting only for the gravity force operator and the third momentum exchange force operator; updating the third horizontal velocity using the third set of dynamic equations accounting only for the friction force operator; and integrating the first horizontal velocity and the second horizontal velocity using the first set of dynamic equations and the second set of dynamic equations accounting only for the gravity force operator and the second momentum exchange force operator.

In any one of the example implementations above, the splitting discretization scheme may include updating the time evolution of the fluid substance and the granular substance asynchronously with the time evolution for the granular substance updated more frequently.

In some other example implementations, an electronic device is disclosed. The electronic device may include a memory for storing computer instructions and a processor for executing the computer instructions to perform any one of the methods above.

In some other example implementations, a computer-readable non-transitory storage medium is disclosed. The storage medium may be configured to store computer instructions. The computer instructions, when executed by a processor of an electronic device, may be configured to cause the electronic device to perform any one of the methods above.

### BRIEF DESCRIPTION OF THE DRAWINGS

For a more complete understanding of the invention, reference is made to the following description and accompanying drawings, in which:

FIG. 1 illustrates example four phases in the geometric setup of height-field simulation of a multi-phase mixture of a material system including a fluid and a granular substance;

FIG. 2 illustrates an example piecewise linear model of sand cohesion as a function a water saturation level;

FIG. 3 illustrates an example horizontal cell grid for simulating dynamics of a mixture of water-sand system over a terrain;

FIG. 4a-FIG. 4h illustrate simulated sand piles with different water saturation levels showing that a cohesive force that holds the sand together increases with a higher saturation level at first and then decreases when the sand is overly saturated, and that an external frictional force keeps decreasing as a result of enlarging buoyancy;

FIG. 5a-FIG. 5c illustrate example simulations for sand castles showing that the sand castle can be pushed forward while largely holding its shape;

FIG. 6 illustrates performance and memory usage for simulating a sand dam breakage with different horizontal simulation grid resolutions;

FIG. 7a-FIG. 7d illustrate example simulations of a water spring flow from a center that pushes surrounding sand away with different sand/water time update ratios;

FIG. 8 illustrates log-log plot of L2 norm of the velocity residual versus iteration number in simulating a water spring with sand with various horizontal cell grid resolutions;

FIG. 9a-FIG. 9d illustrate example simulations for sand dam breach at different evolution times as water from the right slowly erodes a sand dam;

FIG. 10a-FIG. 10b illustrate example simulations for patterns initially enscribed in sand (FIG. 10a) being washed away by water (FIG. 10b);

FIG. 11a-FIG. 11d illustrate example simulations of a sand canyon being flushed by water; and

FIG. 12 shows an example computing system for effectuate simulation and graphical display of dynamics in a fluid and graular substance system.

### DETAILED DESCRIPTION

### Application of Simulation for Flow Dynamics in Heterogeneous Material System

Computer simulation of flows of a mixture of heterogeneous materials in forms of fluid and granular substance, such as water and sand, usually involves complex modeling, excessive computation resources, and a large memory space utilization. In applications where real-time or near-real time simulation is needed in an environment limited by computation and networking resources, a simplistic yet realistic physical model in combination with an efficient computation procedure may become critical. Such applications include but are not limited to real-time generation of graphics in video games, virtual reality, augmented reality, an other immersive interactive applications.

The heterogeneous materials in such a mixture may contain a combination of these materials or substances in various forms or phases. In an example water-sand mixture, for example, the various phases may include a fluid phase containing only the water, a mixed phase containing both water and wet sand at various water saturation levels, and a solid phase containing only the granular sand. The flow dynamics includes movement of portions of each of these phases in the heterogeneous material system and the exchange of mass between the phases driven by various external and internal forces.

In some example implementations, meshless methods for tracking a large number of particles to represent the materials with different attributes or phases, such as Smoothed Particles Hydrodynamics (SPH) method, Discrete-Element Method (DEM), and hybrid SPH-DEM, may be used for simulating the dynamics of the these heterogeneous material systems. However, these methods may become intractable when the amount of particle-particle interactions becomes excessive in large-scale 3D scenarios. In some other example implementations, to mitigate computational cost, hybrid Eulerian/Lagrangian methods, as well as more efficient methods such as the Material Point Method (MPM), may be employed by handling the interactions between particles on a coarse Eulerian grid, while tracking the dynamics in Lagrangian space using particles. However, dealing with large-scale scenarios using MPM still requires a large number of particles, making them nearly intractable for real-time applications.

In order to achieve real-time computation in applications such as video games and other interactive environment (immersive application, virtual reality, augmented reality at video frame rates, and the like), trade-offs may need to be made between simulation fidelity and performance, particularly in order to fit the computation into lower-end desktop or mobile devices.

In the disclosure below, dynamics of such a water-sand system is modeled as having multiple layers with distinct phases over a predefined terrain. The multiple phases, for example, may include a water phase, a mixed water-sand phase, and the solid sand phase. The terrain may be divided into a plurality of grid-like horizontal cells. Each of the horizontal cells may be associated with horizontal coordinates x and y. The dynamics of each of the multiple phases and the water-sand mixture may be tracked in each of the plurality of horizontal cells using separate but coupled physical models for the water and sand based on mass conservation of water and sand from cell to cell, and driven by various intra-cell and inter-cell forces between the various phases as well as external forces such gravity and friction from the terrain. One or more of the multiple phases may be present in the vertical direction in each horizontal cell, forming stacked columns or layers of different phases. The depth of a layer (or a phase) as a function of the horizontal cells may be referred to as a height field for that phase. Each of the layers and or phases may be associated with a corresponding height field. The physical model is further based on a shallow-water assumption such that vertical velocities in the water-sand system is considered negligible. As such, each of the layer or column of different phases in each horizontal cell may also be described by a horizontal velocity representing its flow in addition to its depth (height). The velocity of a layer of all cells thus form a velocity field of that layer. The height fields and velocity fields of each of the phases may be used as a basis for generating a graphical representation of the flow dynamics of the water-sand system. The physical model includes depth integrated governing equations that are capable of modeling an elastoplastic behavior of wet sand, as well as sand-water flow and mixing phenomena such as mass conservation, friction, diffusion, saturation, and momentum exchange. These phenomena are expressed as various continuity and force operators (representing accelerations). In performing time-evolution dynamics of the water-sand system in each of a sequence of time steps, a splitting of the various operators is adopted, providing a stable and computation efficient time integration in real-time and under moderate time step sizes. In addition, the time updates for the water phases and the sand phase may be performed in an asynchronous manner. In particular, the time update of the sand phase may be performed more frequently than the time update for the water. In such a manner, efficiency and of the simulation may be improved without much degradation of simulation performance. The disclosed approach may run at real-time frame rates and achieves a desirable trade-off between fidelity and performance for immersive experience for interactive applications.

The depth-integrated governing equations for the various phases under the shallow-water assumption and traced using the spatial-temporal splitting-operator integration thus provide an effective dimension reduction from a 3D computation of the fluid and granular substance mixture system to 2.5D computation. The example implementations disclosed below allow for a modeling of an elastoplastic behavior of wet sand, as well as sand-water-mixing phenomena, on top of the shallow water framework. The spatial-temporal discretization scheme for the governing equations and the use of operator-splitting to handle each force term, including water diffusion, external friction, internal elastoplastic force, and momentum exchange between the phases and the cells. A piecewise linear function is define to describe a relationship between sand cohesion and water saturation in order to simulate the elastoplastic force. Fixed-point iterations are further adopted to cope with instability issues due to stiff elastoplastic forces. An asynchronous update routine is used to improve the performance. As a result, the implementations disclosed below allow for computation resource-friendly simulation of large-scale sand-water scenarios at real-time frame rates with the following main characteristics:
A 2.5D governing equation for fluid-granular substance mixtures.
A grid-based elastoplastic formulation for the granular substance.
A piecewise linear function to define how elastoplastic force changes with respect to saturation levels of sand.
A semi-implicit operator splitting and a spatial-temporal discretization scheme.
An asynchronous updating scheme for the fluid and the granular substance.

The disclosed implementations are rooted in computer technology itself to improve computing efficiency by specifically designed data structure using the discretization and splitting of operators with respect to computation processes. The output of such specially arranged computation may be used to generate specific digital graphics that would otherwise not be possible.

### Physical Models for the Water-Sand Mixture System: Layered Height-Field Representation

In the disclosure below, the terms “water” and “sand’ may be understood as being used to broadly refer to and interchangeably with “fluid” and “granular substance”, respectively.

For the purpose of real-time simulation of mixtures of fluid and granular substance, such as water-sand mixture, the shallow-fluid assumption or approximation may be used as a first component in order to increase simulation efficiency.

Specifically in the shallow-fluid approximation, the vertical scale along the z-axis is negligible as compared with the horizontal scale so that all governing equations of the dynamics of the fluid and the granular substance can be depth-integrated to eliminate the vertical velocity. The symbol h and v are used to denote height and velocity fields, respectively. As such, h*(x, y) and v*(x, y) are used to indicate the height and velocity at location x=(x, y), where x and y denote horizontal axis-wise components. The superscript “*” is used to represent different phases of the water-sand mixture, as described in more detail below.

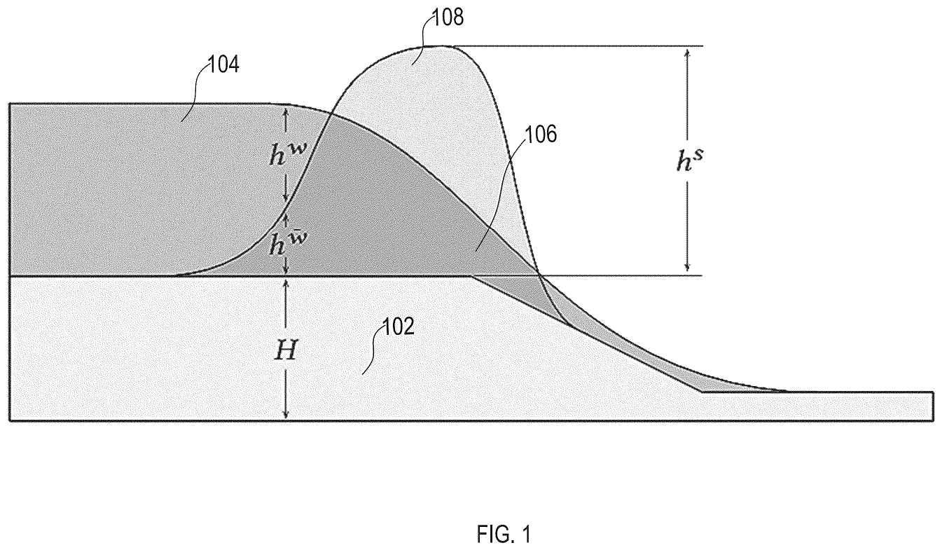

In the various example implementations below, a layered height-field model is used to unify the representation of different water-sand phases, as illustrated in FIG. 1. The various layers of water and sand mixture may lay over a predefined terrain 102. The various layers may include a fluid layer 104 containing only water, a mixed layer 106 containing water-sand mixture, and a solid layer 108 containing only sand. The fluid (water) can flow freely above the mixed water-sand layer or the terrain (in terrain areas having no wet sand) while its movement is impeded by the grains when inside the sand. Due to the significantly different dynamics between the pure and mixed phases, a water column is divided into pure water and mixed water with sand (if containing both). For the sand, an entire sand column is modeled together without considering the vertical variations in terms of mixing with the water. An external friction force between the sand column and the terrain is considered as acting on the entire sand column.

As such, the framework below may be designed to model four height fields:
Terrain height field H, the underneath static ground;
Sand height field h^{s}, the granular materials (including both solid sand and sand mixed with water);
Pure water height field h^{w}, the part of water above wet sand or terrain;
Mixed water h^{w̅}, the part of water submerged under sand.
   In other words, the superscripts s, w, and w̅ are used to denote the sand, pure water, and mixed water phases, respectively.

To achieve real-time performance and to simplify the computation, the following assumptions may also be made’:
First, sand and mixed water can sit immediately on top of the terrain.
Second, pure water can sit on the terrain or mixed water-sand but not on dry sand. Both sand and water may each be provided with a constant density over a simulation domain, i.e., ρ^{s} for sand and ρ^{w} for water are provided as constants. As such, not all four height fields are present in every (x, y) location or cell. For example, as shown explicitly in or otherwise derivable from FIG. 1, in some (x, y) locations, there are only water over the terrain. In the various (x, y) locations, these combinations of the height fields from top to bottom may be possible: water followed by terrain, water followed by water/sand mixture followed by terrain, water/sand mixture followed by terrain, solid sand followed by water/sand mixture followed by terrain, and solid sand followed by terrain.
Third, different phases, such as sand, pure water, and mixed water, can carry different velocities.
It is assumed that the mixed water is exactly the part of water submerged under the sand. For example, h^{w̅}=min(h^{ŵ}+h^{w}, h^{s}), where h^{w̅}+h^{w} represents the height of the entire water column.

### Physical Models for the Water-Sand Mixture System: Two-Layer Shallow-Water Equations

For the two-layer shallow water layers above, in which water is divided into pure water and mixed water, governing equations based on mass conservation and various mass exchanges for the pure water and the mixed water may be separately constructed as:

$$\frac{{Dh}^{w}}{Dt} = - {h}^{w} ∇ \cdot {v}^{w} , \qquad ( 1 )$$

$$\frac{{Dh}^{\overline{w}}}{Dt} = - {h}^{\overline{w}} ∇ \cdot {v}^{\overline{w}} + {c}_{d} ∇ \cdot ∇ {h}^{\overline{w}} , \qquad ( 2 )$$

where h^{w} is the height field of pure water, h^{w̅} is the height filed of mixed water, D/Dt represents time derivative, the horizontal velocity of the pure water and mixed water are represented by v^{w}=(u^{w}, v^{w}) and v^{w̅}=(u^{w̅}, v^{w̅}), respective (contains the velocity components along the x-axis and y-axis), ∇·∇ is the Laplace operator for modeling the diffusion of water in porous media, and c_{d} is the diffusion rate.

As such, height field of the pure water above is based on mass conservation as a result of flow (the first terms −h^{w}∇·v^{w}, representing a continuity operators indicating net gain or loss of water due to horizontal net water flow in or out of a pure water column), whereas the governing equation for the mixed water height field is based on both mass conservation as a result of flow (the first terms −h^{w̅}∇·v^{w̅}, representing a continuity operators indicating net gain or loss of water due to horizontal net water flow in or out of a mixed water column) and mass exchange as a result of mixed water diffusion relative to the wet sand (the term c_{d}∇·∇h^{w̅}, referred to as a diffusive mass exchange operator).

In some example implementations, the governing equations for the velocity v^{w} of the pure water and the velocity v^{w̅} of the mixed water may be constructed as follows:

$$\frac{{Dv}^{w}}{Dt} = - g ∇ ( H + {h}^{w} + {h}^{\overline{w}} ) + {a}_{ℳ}^{w} , \qquad ( 3 )$$

$$\frac{{Dv}^{\overline{w}}}{Dt} = - g ∇ ( H + {h}^{w} + {h}^{\overline{w}} ) + {a}_{ℳ}^{\overline{w}} + {a}_{𝒟}^{\overline{w}} , \qquad ( 4 )$$

where H is the terrain height field, g is the gravitational constant, a*_{M} indicates the acceleration caused by momentum exchange (“*” being either “w” or w̅, and a_{D}^{w̅} indicates the acceleration caused by mixed water diffusion, which may only happen within the granular media between mixed water and sand.

The first term in each of the governing equations above may be referred to as gravity force operator and represents acceleration included by horizontal gravitational components. The horizontal gravitation force component acting on the pure water column is from the gravity of the pure water itself whereas the horizontal gravitation force component on the mixed water is from both water columns. The formulation and modeling for the momentum exchange force operator a*_{M} and the diffusion force operator a_{D}^{w̅ are described in further detail below.}

### Physical Models for the Water-Sand Mixture System: Governing Equations for Sand

In some example implementations, modeling of the dynamics of the sand columns may be governed by mass conservation, momentum exchange force, elastoplastic force, and external friction from the terrain. For example, the governing equations of the sand column may be constructed as follows:

$$\\ \begin{matrix}\frac{{Dh}^{{}_{} s}}{Dt} = - {h}^{{}_{} s} ∇ \cdot {v}^{{}_{} s} , & ( 5 )\end{matrix}$$

$$\\ \begin{matrix}\frac{{Dv}^{{}_{} s}}{Dt} = - g ∇ ( H + {h}^{{}_{} s} + \frac{{ρ}^{{}_{} w}}{{ρ}^{{}_{} s}} {h}^{{}_{} w} ) + {a}_{ℰ}^{{}_{} s} + {a}_{ℐ}^{{}_{} s} + {a}_{ℳ}^{{}_{} s} . & ( 6 )\end{matrix}$$

In the sand governing equations above, the sand height field dynamics is determined by a horizontal continuity operator. The horizontal acceleration of the sand is produced by several force operators, including the gravity operator (the first term of Eq. 6, an internal elastoplastic force operator a_{I}^{s} between sand grains, an momentum exchange force operator a_{M}^{s} for momentum exchange from the mixed water phase, and a friction operator a_{ε}^{s} for modeling the external frictional force between the sand and the ground. As part of the gravity operator, the term h^{w}ρ^{w}/ρ^{s} expresses the pressure of pure water on the sand phase, accounting for the difference in their densities. The formulation and modeling for the momentum exchange force operator a_{M}^{s}, the external frictional force operator a_{ε}^{s}, and the internal elastoplastic force operator a_{I}^{s} are described in further detail below.

External Frictional Force and Elastoplastic Internal Force with Respect to Sand

The friction above need to be taken into account because during the sand piling process, relative motions may exist between sand and the terrain underneath. In some example implementations, such external friction between the sand and terrain may be modeled as a force opposite to the movement direction and proportional to the normal contact force f_{C} between the sand and the terrain. Correspondingly, such an external frictional force f_{ε} may be modeled as:

$$\\ \begin{matrix}{f}_{ℰ} = - μ g {f}_{𝒞} \hat{v} , & ( 7 )\end{matrix}$$

$$\\ {f}_{𝒞} = {ρ}^{{}_{} s} {h}^{{}_{} s} - {ρ}^{{}_{} w} {h}^{{}_{} \overline{w}} ,$$

where \hat{v} represents velocity direction (unit horizontal velocity vector), μ represents the frictional coefficient, and the second term in f_{C} arises from buoyancy as a lifting force from water that decreases the normal force on the terrain.

The elastoplastic force included in the governing equation for the dynamics of the sand phase is included in order to model the internal frictional force between the sand grains. In some implementations, a shear and normal stresses of sand may be modeled as being related as a continuum. For example, the stress in the sand may be expressed as:

$$\\ σ = \frac{1}{det ( F )} \frac{\partial ψ}{\partial F} {F}^{{}_{} T} ,$$

where F represents the deformation gradient and ψ represents the elastic energy density. To capture cohesive effects of water saturation in the mixed layer, the following condition may be observed:

$$\\ {c}_{f} tr ( σ ) + ‖ σ - \frac{tr ( σ )}{d} I ‖ \leq {c}_{c} ( ϕ ) ,$$

where c_{f}≥0 models the amount of friction between grains and c_{c}≥0 models the level of cohesion between grains, which is a function of water saturation level ϕ in the sand. In some example implementations, this water saturation level ϕ may be approximated as the volume fraction of water in the mixture:

$$\\ ϕ = \frac{{h}^{{}_{} w} + {h}^{{}_{} \overline{w}}}{{h}^{{}_{} w} + {h}^{{}_{} \overline{w}} + {h}^{{}_{} s}} .$$

Under the shallow assumption also for the sand, the vertical velocity of sand is negligible. As such only the horizontal deformation gradient field F∈ [symbol] ^{2×2} need to be tracked. Such horizontal deformation gradient may evolve in time according to:

$$\\ \frac{DF}{Dt} = \frac{\partial v}{\partial x} F .$$

In addition, the depth-integrated elastoplastic internal force [symbol] may take the form of:

$$\\ {f}_{ℐ} = ( \frac{\partial ( {h}^{{}_{} s} {σ}_{xx} )}{\partial x} + \frac{\partial ( {h}^{{}_{} s} {σ}_{xy} )}{\partial y} , \frac{\partial ( {h}^{{}_{} s} {σ}_{yx} )}{\partial x} + \frac{\partial ( {h}^{{}_{} s} {σ}_{yy} )}{\partial y} ) .$$

The momentum contribution from the external friction force and elastoplastic internal force (the friction force operator and the elastoplastic force operator in the sand governing equations above) may be averaged on the whole column of sand as:

$$\\ {a}_{ℰ} = \frac{{f}_{ℰ}}{{ρ}^{{}_{} s} {h}^{{}_{} s}} , {a}_{ℐ} = \frac{{f}_{ℐ}}{{ρ}^{{}_{} s} {h}^{{}_{} s}} .$$

### Saturation States of Wet Sand for Modeling the Elastoplastic Force

The elastoplastic force may depend on sand cohesion c_{c} as described above. The sand cohesion, in turn, may depend on water saturation level in the sand. For example, dry sand may have specific repose angles whereas adding a small amount of water makes the sand stiffer. However, sand grains may collapse rather than cohere together when a large amount of water is added. Microscopically, with the increase in water content, the morphology of the water phase in the sand can be categorized as pendular, funicular, and capillary.

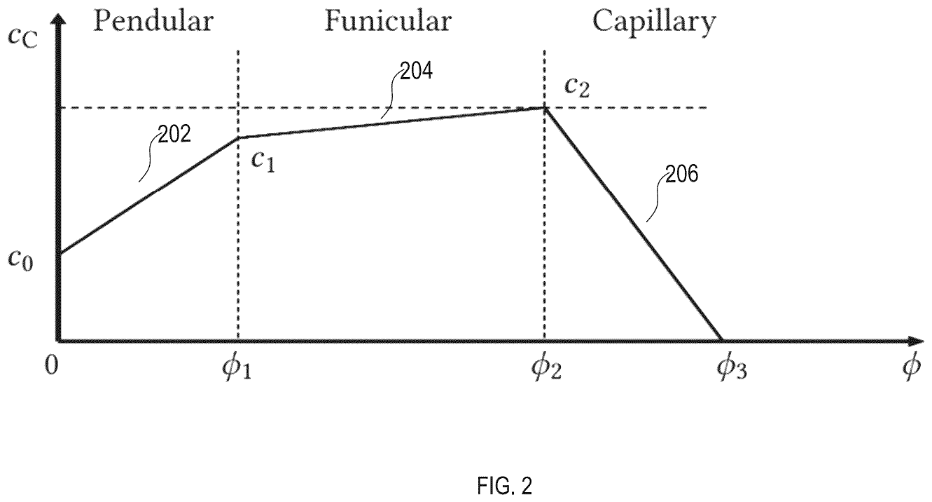

In the pendular state (usually the level of saturation is less than 10%), for example, isolated water bridges may be formed between grains, thereby producing attractive forces that enhance the sand cohesion significantly. With the increase in water content, the water bridges may begin to coalesce with each other to form liquid clusters and reduce the capillary force slightly. This is canceled out by the extension of rupture distance and leads to constant capillary cohesion. When the sand and water reach the capillary state of full saturation, the cohesion is reduced to about zero. To simplify the modeling and for more efficient simulation, this cohesion phenomenon may be modeled using a piecewise linear function of water saturation level as illustrated in FIG. 2. Such functional relationship between the cohesion c_{c} and the water saturation ϕ may be expressed as:

$$\\ {c}_{c} ( ϕ ) = \{ \begin{matrix}{c}_{0} + ϕ \frac{{c}_{1} - {c}_{0}}{{ϕ}_{1}} , & if 0 \leq ϕ < {ϕ}_{1} \\ {c}_{1} + ( ϕ - {ϕ}_{1} ) \frac{{c}_{2} - {c}_{1}}{{ϕ}_{2} - {ϕ}_{1}} , & if {ϕ}_{1} \leq ϕ < {ϕ}_{2} \\ {c}_{2} \frac{{ϕ}_{3} - ϕ}{{ϕ}_{3} - {ϕ}_{2}} , & if {ϕ}_{2} \leq ϕ \leq {ϕ}_{3} \\ 0 , & if ϕ > {ϕ}_{3}\end{matrix} ,$$

by assuming that the cohesion of sand first grows rapidly with saturation increase to reach a certain value c₁, as shown by 202 of FIG. 2, then slowly approaches its maximal value c₂, as shown by 204 of FIG. 2. Beyond this point, cohesion keeps decreasing with more water saturated and eventually becomes zero again, as shown by 206 of FIG. 2.

### Sand and Fluid Coupling: Diffusion and Momentum Exchange

The coupling between the sand and the water may be modeled as diffusion and momentum exchange, as used in the example governing equations above.

For example, water may diffuse from one space to a neighboring space within wet sand, leading to an effective mass and velocity exchange. As described above, mass diffusion is modeled by the term c_{d}∇·∇h^{w̅} in Eq. 1. Similarly, the acceleration caused by the depth-integrated velocity diffusion within the porous sand may be described as follows:

$$\\ \begin{matrix}{a}_{𝒟}^{{}_{} \overline{w}} = {c}_{d} \frac{∇ \cdot ∇ ( {h}^{{}_{} \overline{w}} {v}^{{}_{} \overline{w}} )}{{h}^{{}_{} \overline{w}}} , & ( 8 )\end{matrix}$$

where c_{d} represents the diffusion rate.

In addition, a first type of momentum exchange may occur when water and sand flow through each other and is modeled as the additional acceleration term [symbol] in the momentum conservation equations (Eq. 6) for the sand. Considering a mixed water column h^{w̅} being collocated with a sand column h^{s}, the amount of momentum exchange may be expressed as:

$$\\ {ℳ}^{{}_{} s \to \overline{w}} = - {ℳ}^{{}_{} \overline{w} \to s} = {c}_{e} {h}^{{}_{} \overline{w}} ( {v}^{{}_{} s} - {v}^{{}_{} \overline{w}} ) ,$$

where cₑ is the exchange rate and [symbol] ^{w̅→8} is the amount of momentum transferred [symbol] from mixed water ti to sand s phase per unit time and horizontal area.

A second type of momentum exchange may occur as a result of the shallow water assumptions. Due to h^{w̅} being an induced variable and the change of sand height h^{s}, some parts of mixed water can become pure water and vice versa. As the two water phases carry different velocities, the momentum exchange between them may be modeled, which may be formulated as:

$$\\ {ℳ}^{{}_{} w \to \overline{w}} = - {ℳ}^{{}_{} \overline{w} \to w} = {ρ}^{{}_{} w} ( max ( \frac{\partial {h}^{{}_{} s}}{\partial t} , 0 ) {v}^{{}_{} w} + min ( \frac{\partial {h}^{{}_{} s}}{\partial t} , 0 ) {v}^{{}_{} \overline{w}} ) ,$$

where the formula in the bracket is essentially an up-winding scheme for selecting velocity according to height field flow direction.

The accelerations (the various momentum exchange operators above) caused by the momentum exchanges may be the momentum exchanges averaged over the whole column of the sand, pure water, and mixed water, respectively, and as follows:

$$\\ {a}_{ℳ}^{{}_{} s} = \frac{{ℳ}^{{}_{} \overline{w} \to s}}{{ρ}^{{}_{} s} {h}^{{}_{} s}} , {a}_{ℳ}^{{}_{} w} = \frac{{ℳ}^{{}_{} \overline{w} \to w}}{{ρ}^{{}_{} w} {h}^{{}_{} w}} , {a}_{ℳ}^{{}_{} \overline{w}} = \frac{{ℳ}^{{}_{} s \to \overline{w}} + {ℳ}^{{}_{} w \to \overline{w}}}{{ρ}^{{}_{} w} {h}^{{}_{} \overline{w}}} .$$

### Numerical Updating Process: Asynchronicity, and Spatial-Time Discretization and Operator Splitting

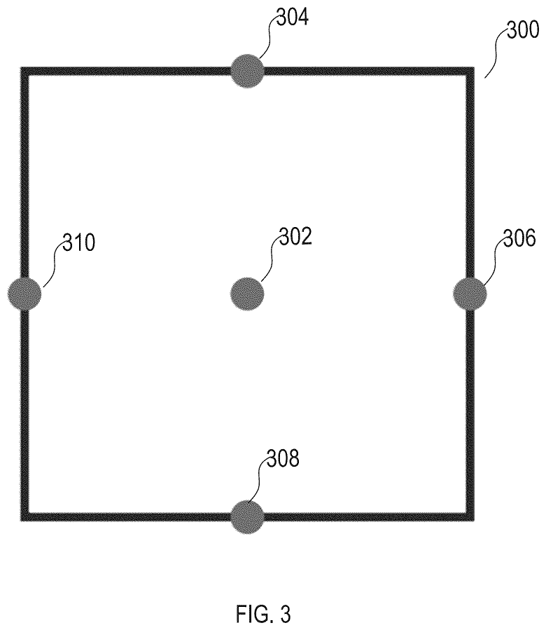

In some example implementations, for numerical simulation based on the various governing equations above, a spatial and temporal discretization scheme may be employed. The simulation domain may be divided into a plurality of horizontal cells. The plurality of horizontal cells may be grid-like. Specifically, a Marker-and-Cell (MAC) grid may be designed to store each height field. For example, heights and deformation gradients may be stored at cell centers, and velocities v* [symbol] (u*, v*) may be stored at face centers of the horizontal cells. Subscripts i, j are used to denote the i, jth cell center, and the fractional index indicates the face center, i.e., i+½, j may be used to indicate the east face center of the i, jth horizontal cell. Symbols Δx and Δt are used to denote the cell size and the time step size, respectively. An example horizontal cell is shown in FIG. 3 as 300, including cell center 302 and face centers 304, 306, 308, and 310.

Merely as one example, the spatial and temporal discretization scheme with operator splitting may be performed based on the water and sand governing equations following these updating steps for water and sand height fields and horizontal velocities at each of a plurality of sequential times with time step Δt:

Algorithm 1 Spatial and temporal discretization
scheme with Operator Splitting

| | |
|---|---|
| 1: | Diffuse mixed water to update mixed water height field and mixed |
| | water velocity; |
| 2: | Integrate water and mixed water heights due to the continuity |
| | operator; |
| 3: | Integrate water and mixed water velocities due to momentum |
| | exchange; |
| 4: | Integrate sand height field; |
| 5: | Integrate sand velocity with elastoplastic force operator based on |
| | deformation gradient; |
| 6: | Integrating sand velocity from gravity and moment exchange force |
| | operators, and correct mixed water velocity |
| 7: | Update sand velocity with friction force. |

Algorithm 1 above uses same time step size for updating height fields and velocities of water and sand. The steps in Algorithm 1 above may be performed in each of the plurality of progressive sequential times with time step Δt in each time step. Update in each of the time steps starts with the values of the height fields and velocities at a previous time step. The final updated height fields and velocities at the end of all the time steps form the description of the time evolution of the height fields and velocities.

In some other example implementations, the time steps for updating height fields and velocities may be made different between water and sand. Such an algorithm may be referred to as an asynchronous updating algorithm. One example is shown below as Algorithm 2:

Algorithm 2 Spatial and temporal discretization
scheme with Operator Splitting

| | |
|---|---|
| 1: | Diffuse mixed water to update mixed water height field and mixed |
| | water velocity; |
| 2: | Integrate water and mixed water heights due to the continuity |
| | operator; |
| 3: | Integrate water and mixed water velocities due to momentum |
| | exchange; |
| 4: | for i = 1 to T do |
| | 4.1: Integrate sand height field; |
| | 4.2: Integrate sand velocity with elastoplastic force operator |
| | based on deformation gradient; |
| | 4.3: Integrating sand velocity from gravity and moment exchange |
| | force operators, and correct mixed water velocity |
| | 4.4: Update sand velocity with friction force. |
| | End for |

The steps above in Algorithms 2 are also performed in each of the plurality of progressive sequential time steps and the final updated height fields and velocities at the end of all the time steps form the description of the time evolution of the height fields and velocities. The for-loop above in Algorithm 2 is implemented to introduce an asynchronicity between the fluid (water) simulation and sand simulation. Specifically, each simulation time step for the water Δt may be divided into a plurality (T) finer sub time steps of sand simulation, as indicated by the for-loop above in Algorithm 2 in order to achieve a desired simulation performance. With such asynchronicity, the simulation time step for the sand is thus 1/T of that of the fluid (water) in this example, Δt/T.

At least one of the reasons to introduce the asynchronicity of Algorithm 2 above may be due to the stiffness of the sand internal force [symbol] , which may necessitate smaller time step to advance sand simulation. The asynchronous simulation of fluid and sand above is configured to achieve an acceptable real-time performance of sand simulation while avoid wasteful updating of fluid height fields and velocities at a frequency higher than necessary.

In some example implementations, appropriate time step size for water updates and time step size for sand updates may be first determined. For example, the amount of computational effort applied to each simulated substances may be adaptively determined. More specifically, time step size for water, denoted as Δt_{w} may be calculated based on the CFL condition. The water species may then be simulated alone, assuming sand is non-existent. Usually, water's CFL number is significantly larger than sand's, thus Δt_{w} may then be further divided into smaller steps Δt_{w} for updating sand height field and velocity. In the example Algorithm 2 above, Δt_{w} may be a T multiple of Δt^{w}.

These example updating steps of, e.g., Algorithm 2, by splitting the update of various operators are described in further detail below.

### Step 1: Updating Mixed Water Height Field and Velocity Due to Diffusion

In Step 1, at a particular time, mixed water height field from the previous time at each horizontal cell may be updated based Eq. 2 and Eq. 4 considering only the operators related to mixed water diffusion. This step may be referred to as the diffusion step.

Specifically, the diffusion step would only consider the following discrete terms, which exchange both mass and momentum across neighboring cells:

$$\\ \begin{matrix}\frac{D ( {h}^{{}_{} w} + {h}^{{}_{} \overline{w}} )}{Dt} = {c}_{d} ∇ \cdot ∇ {h}^{{}_{} \overline{w}} & ( 9 )\end{matrix}$$

$$\\ \begin{matrix}\frac{{Dv}^{{}_{} \overline{w}}}{Dt} = {a}_{𝒟}^{{}_{} \overline{w}} , & ( 10 ) .\end{matrix}$$

Such discrete mass diffusion (Eq. 9) may be solved for updating the mixed water height field via an explicit Euler time integrator as:

$$\\ {h}_{i , j}^{{}_{} \overline{w}} ← {h}_{i , j}^{{}_{} \overline{w}} + {c}_{d} \frac{Δ t}{Δ {x}^{{}_{} 2}} ( {h}_{i + 1 , j}^{{}_{} \overline{w}} + {h}_{i - 1 , j}^{{}_{} \overline{w}} + {h}_{i , j + 1}^{{}_{} \overline{w}} + {h}_{i , j - 1}^{{}_{} \overline{w}} - 4 {h}_{i , j}^{{}_{} \overline{w}} ) .$$

where the arrow represents time update, height field values on the right side of the arrow are from the previous time step, the height field on the left side of the arrow is for the time step being updated, and i and j are integers representing horizontal cell indices.

For the cell neighboring the domain boundary, the Neumann boundary condition ∇ₙh^{w̅}=0 may be used, where subscript n denotes the normal direction at the boundary, and set out-of-bound h^{w̅} to be equal to the value of its nearest neighbor. The above scheme is designed also to conserves mass.

As the momentum (Eq. 10) does not need to be exactly conserved, face-centered heights and cell-centered velocity of the mixed water may be approximated with bilinear interpolation. The discrete diffusion of momentum may be used to update the one horizontal component of the mixed water velocity u^{w̅} as:

$${u}_{i + 1 / 2 , j}^{\overline{w}} ← {u}_{i + 1 / 2 , j}^{\overline{w}} + {c}_{d} \frac{Δ t}{Δ {x}^{2}} ( {u}_{i + 1 , j}^{\overline{w}} ( {h}_{i + 3 / 2 , j}^{\overline{w}} - {h}_{i + 1 / 2 , j}^{\overline{w}} ) - {u}_{i , j}^{\overline{w}} ( {h}_{i + 1 / 2 , j}^{\overline{w}} - {h}_{i - 1 / 2 , j}^{\overline{w}} ) + {u}_{i + 1 / 2 , j + 1 / 2}^{\overline{w}} ( {h}_{i + 1 / 2 , j + 1}^{\overline{w}} - {h}_{i + 1 / 2 , j}^{\overline{w}} ) - {u}_{i + 1 / 2 , j - 1 / 2}^{\overline{w}} ( {h}_{i + 1 / 2 , j}^{\overline{w}} - {h}_{i + 1 / 2 , j - 1}^{\overline{w}} ) ) ,$$

and a symmetric equation of the above applies to the other horizontal velocity component v^{w̅} of the mixed water.

### Step 2: Integrating Water and Mixed Water Heights Due to the Continuity Operator

Next at Step 2, water and mixed water height may be further updated based on previous or updated velocities values so far using the mass-conserved (or continuity) portion of the water or mixed water height governing equation:

$$\frac{{Dh}^{★}}{Dt} = - {h}^{★} ∇ \cdot {v}^{★} ,$$

where * can be w and w̅.

A predictor-corrector scheme may be used to integrate the height h^{w} and h^{w̅} as separate phases (predictor). In particular, a conserved up-winding advection scheme may be used, which may be defined as:

$$\begin{matrix}{h}_{i , j}^{★} ← {h}_{i , j}^{★} + \frac{Δ t}{Δ x} ( {u}_{i + 1 / 2 , j}^{★} {𝒰}_{i + 1 / 2 , j} ( {h}^{★} ) - {u}_{i - 1 / 2 , j}^{★} {𝒰}_{i - 1 / 2 , j} ( {h}^{★} ) ) \\ + \frac{Δ t}{Δ x} ( {v}_{i , j + 1 / 2}^{★} {𝒰}_{i , j + 1 / 2} ( {h}^{★} ) - {v}_{i , j - 1 / 2}^{★} {𝒰}_{i , j - 1 / 2} ( {h}^{★} ) ) .\end{matrix}$$

The up-winding selector [symbol] (h) may be defined as:

$${𝒰}_{i + 1 / 2 , j} ( {h}^{★} ) = max ( {u}_{i + 1 / 2 , j}^{★} , 0 ) {h}_{i , j}^{★} + min ( {u}_{i + 1 / 2 , j}^{★} , 0 ) {h}_{i + 1 , j}^{★} .$$

The momentum exchange may be computed based on the difference between the expected mixed water height min(h^{w̅}+h^{w}, h^{s}) and the current mixed water height h^{w̅} as a corrector:

$${[ {ℳ}^{w \to \overline{w}} ]}_{i + 1 / 2 , j} ← {\frac{{ρ}^{w}}{Δ t} [ max ( min ( {h}^{\overline{w}} + {h}^{w} , {h}^{s} ) - {h}^{\overline{w}} , 0 ) {u}^{w} ]}_{i + 1 / 2 , j} + {\frac{{ρ}^{w}}{Δ t} [ min ( min ( {h}^{\overline{w}} + {h}^{w} , {h}^{s} ) - {h}^{\overline{w}} , 0 ) {u}^{\overline{w}} ]}_{i + 1 / 2 , j} ,$$

where a symmetric equation applies to [ [symbol] ^{w→w̅}]_{i,j+1/2}.

After computing [symbol] ^{w→w̅}, the real mixed water height may be recovered via h^{w̅}←min(h^{w̅}+h^{w}, h^{s}), as h^{w̅} is implicitly an induced variable defined by the sand and water height.

### Step 3: Integrating Water and Mixed Water Velocities

Once the momentum exchange between two water phases is computed as indicated above in Step 2, the water and mixed water velocities may be updated in Step 3 considering the gravity operator and the momentum exchange operator in

$$\frac{{Dv}^{★}}{Dt} = - g ∇ ( H + {h}^{w} + {h}^{\overline{w}} ) + {a}_{ℳ}^{★} .$$

In some example implementations, to further discretize the update, an unconditionally stable Semi-Lagrangian advection scheme may first be used to update the velocities and then the velocities may be further explicitly updated by taking the gradient of the water or mixed water height into account as:

$${u}_{i + 1 / 2 , j}^{★} ← {u}_{i + 1 / 2 , j}^{★} + Δ {t [ {a}_{ℳ}^{★} ]}_{i + 1 / 2 , j} - Δ tg \frac{{[ H + {h}^{w} + {h}^{\overline{w}} ]}_{i + 1 , j} - {[ H + {h}^{p} + {h}^{\overline{w}} ]}_{i , j}}{Δ x} ,$$

and the case with v*_{i,j+1/2} is symmetric to the above for.

### Steps 4: Integrating Sand Height Field

In some example implementations, for each time update for sand height field and velocity, T finer sub-time steps may be literately performed, as shown by the for loop in Algorithm 1 above. Similar to the fluid (water) integration scheme above, time integration of sand height field and velocity may be based on the splitting scheme, which consists of four steps: sand height integration, sand velocity update from elastoplastic force operator based on deformation gradient, sand velocity integration, and applying external frictional force.

### Step 4.1: Integrating Sand Height Field Based on Mass Conservation (Continuity Operator)

We begin by using ?? to solve the following sand height integration equation:

$$\frac{{Dh}^{s}}{Dt} = - {h}^{s} ∇ \cdot {v}^{s} .$$

Step 4.2: Updating Sand Velocity with Elastoplastic Force Operator Based on Deformation Gradient

Since the elastoplastic internal force is much stiffer than other forces, semi-implicit integration may be performed to achieve stable integration under a relatively large time step size, which is the key to real-time simulation. For example, the deformation gradient F of sand may be integrated using a semi-implicit scheme. A semi-Lagrangian advection scheme may first be adopted to account for the material derivative DF/Dt. Then, the following backward Euler scheme for jointly updating v^{s} and F may be considered next:

$$\frac{{Dv}^{s}}{Dt} = {a}_{ℐ}^{s} ( F ) ,$$

$$\frac{DF}{Dt} = \frac{\partial {v}^{s}}{\partial x} F .$$

The above system of equations may be solved by formulating it as the following fixed-point iteration:

$${v}^{s , t + 1} ← {v}^{s , t} + Δ {ta}_{ℐ}^{s} ( {F}^{t + 1} ) ,$$

$${F}^{t + 1} ← {F}^{t} + Δ t \frac{\partial {v}^{s , t + 1}}{\partial x} {F}^{t} ,$$

where superscripts t and t+1 are used to denote the current iteration t and the next iteration t+1. The fixed point iterations significantly stabilize the time integrator and allow a larger fine time step size.
Step 4.3: Integrating Sand Velocity from Gravity and Moment Exchange Force Operators, and Correct Mixed Water Velocity

In Step 4.3, the sand velocity may be further updated with gravitational force operator and the momentum exchange operator according to:

$$\frac{{Dv}^{s}}{Dt} = - g ∇ ( H + {h}^{s} + \frac{{ρ}^{w}}{{ρ}^{s}} {h}^{w} ) + {a}_{ℳ}^{s} ,$$

which can be solved the same way as for the water, i.e.,

$${u}_{i + 1 / 2 , j}^{s} ← {u}_{i + 1 / 2 , j}^{s} + Δ {t [ {a}_{ℳ}^{s} ]}_{i + 1 / 2 , j} - Δ tg \frac{{[ H + {h}^{s} + \frac{{ρ}^{w}}{{ρ}^{s}} {h}^{w} ]}_{i + 1 , j} - {[ H + {h}^{s} + \frac{{ρ}^{w}}{{ρ}^{s}} {h}^{w} ]}_{i , j}}{Δ x} ,$$

and symmetric equations apply to the v component of the sand horizontal velocity.

The acceleration due to momentum exchange between the mixed water and the sand can be calculated via

$${[ {a}_{ℳ}^{s} ]}_{i + 1 / 2 , j} ← - {\frac{{c}_{e}}{{ρ}^{s} {h}^{s}} [ {h}^{\overline{w}} ( {u}^{s} - {u}^{\overline{w}} ) ]}_{i + 1 / 2 , j} .$$

This, in return, corrects the mixed water's velocities as:

$${u}_{i + 1 / 2 , j}^{\overline{w}} ← {u}_{i + 1 / 2 , j}^{\overline{w}} - Δ t {\frac{{ρ}^{s} {h}^{s}}{{ρ}^{\overline{w}} {h}^{\overline{w}}} [ {a}_{ℳ}^{s} ]}_{i + 1 / 2 , j} .$$

The case with and [ [symbol] ]_{i,j+1/2} and v^{w̅}_{i,j+1/2} is, again, symmetric.
Step 4.4: Updating Sand Velocity with Friction Force Operator

In some example implementations, the frictional force can be treated as an external force according to the maximal dissipation principle. Both h^{s} and h^{w̅} may be first interpolated on each face center of the horizontal cell and then clamp the sand velocity via:

$${[ {a}_{ε}^{s} ]}_{i + 1 / 2 , j} = μ {g [ \frac{{ρ}^{s} {h}^{s} - {ρ}^{w} {h}^{\overline{w}}}{{ρ}^{s} {h}^{s}} ]}_{i + 1 / 2 , j} {u}_{i + 1 / 2 , j}^{s} ← {u}_{i + 1 / 2 , j}^{s} max ( \frac{‖ {v}_{i + 1 / 2 , j}^{s} ‖ - Δ {t [ {a}_{ε}^{s} ]}_{i + 1 / 2 , j}}{‖ {v}_{i + 1 / 2 , j}^{s} ‖} , 0 ) .$$

Then, u^{s}_{i+1/2j} may be assigned to the face center, and the case with v^{s}_{i,j+1/2} is symmetric.

### Extrapolation

While shallow fluid equations above can be solved to obtain velocities inside an occupied area, velocity and deformation gradient on the untracked side of the surface are needed for accurately advecting quantities of interest using the semi-Lagrangian method and calculating the internal elastoplastic force. To this end, and in some example implementations, the data of interest may be extrapolated by locating the untracked horizontal cell and face centers that neighbor the tracked cells. An average tracked values within the 3×3 neighborhood may be computed and assigned to the untracked horizontal cells.

### Simulation Results

The sand and water mixture model above is evaluated via a CUDA implementation, where the results are rendered in real-time with OpenGL. All timings are measured on a 3.0 GHz Intel Core i9-13900K CPU, NVIDIA GeForce RTX 4080 GPU with 16 GB Memory. A fixed number of fixed-point iterations are used for an efficient GPU implementation to avoid checking residual value. Specifically, 1 iteration may be used. As described below, several examples are first used to test the necessity of each component (e.g., each force operator), followed by a few complex example simulations. It is assumed that a sand levee wall collapses when the saturated water is about half its height, corresponding to ϕ₃=0.33. In some of the simulations below, ϕ₁=0.2 and ϕ₂=0.25 are chosen.

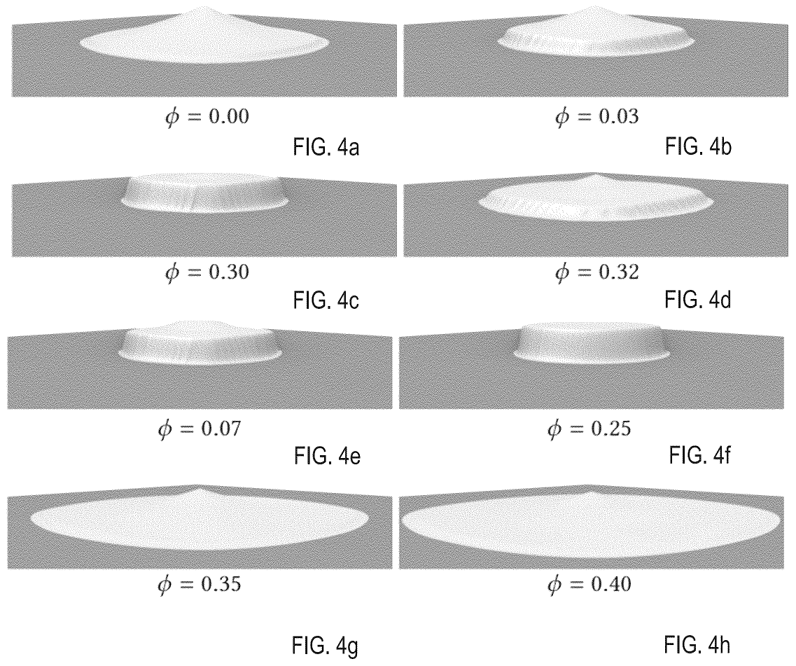

FIG. 4a through FIG. 4h illustrate sand dynamics with different water saturation levels and show that sand can behave quite differently based on saturation. With a low saturation #, the dry sand is fully supported by external friction and forms the angle of repose. With the increase of saturation, the force from the water bridge between the grains dominates, and the sand can preserve its shape under gravity. When the sand and water reach the capillary state of full saturation, the sand collapses since the cohesion is reduced to about zero.

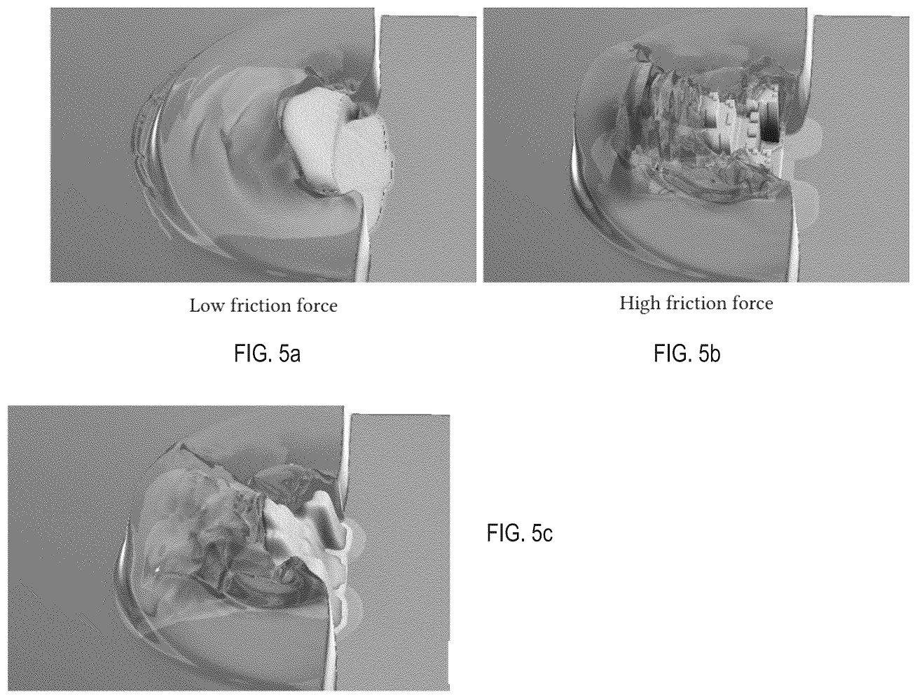

FIG. 5a through FIG. 5c shows simulated sand castles that demonstrate the necessity of elastoplastic internal force described above. In particular, while a high friction force immobilizes and prevents the castle from deforming, a low external friction force cannot hold the castle's shape. FIGS. 5a-5c show that with the presence of elastoplastic force as modeled above, the castle can be pushed forward by the water while largely holding its shape. FIGS. 5a-5c are explained in the Table below.

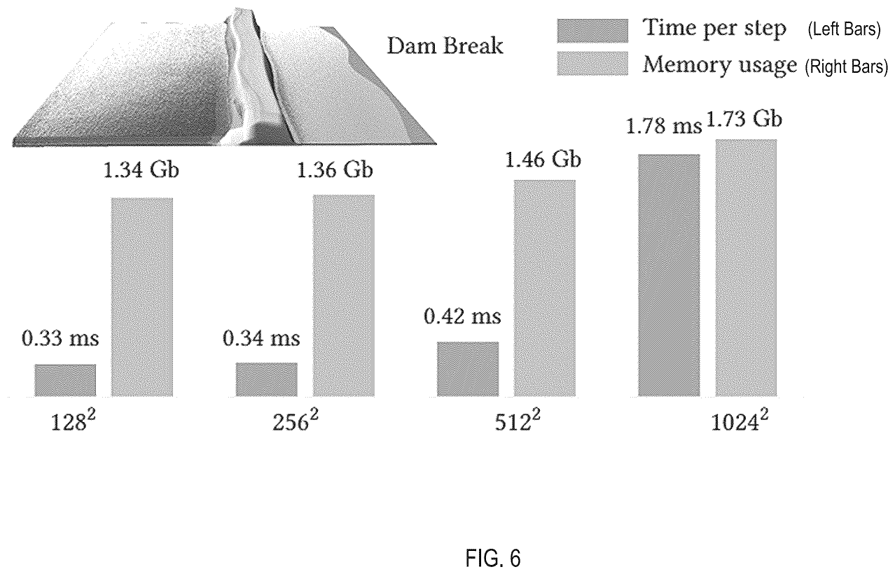

To test the scalability, a “Dam Break” example is shown in FIG. 6 with different horizontal grid resolutions, 128², 256², 512², and 1024², respectively. FIG. 6 shows that the method above can be easily scaled to a large scene with small memory usage. More importantly, the high resolution simulation with a 1024² grid only takes 1.63 ms per step, which makes this technique accessible to real-time applications.

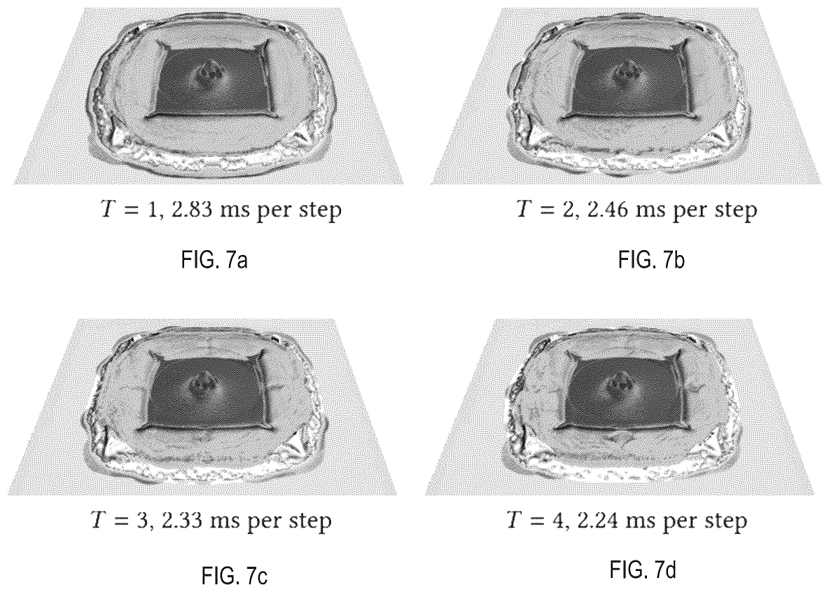

To further evaluate the method of asynchronous water and sand update described above, the same scene is run with different numbers of sand/water time step ratios, shown in the “Spring” examples of FIG. 7, shown time step size to obtain similar simulation performance with different asynchronous ratios. FIG. 7 demonstrate that the asynchronous update can improve the performance by 13%, 17%, and 21%, for T=2, 3, and 4, respectively, at the expense of minor changes in the results.

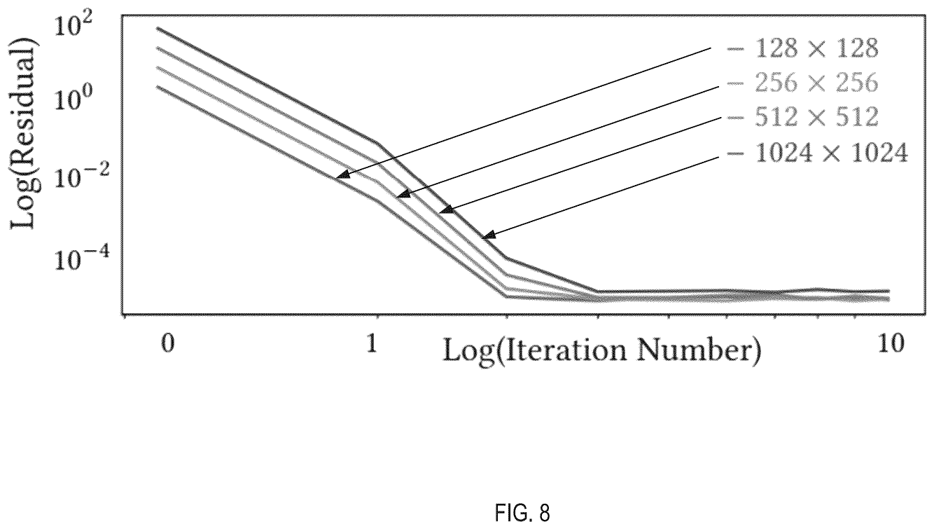

The method above adopts the fixed point iteration method to allow for large time steps. A convergence rate on the “Spring” example above is studied. FIG. 8 illustrates how the L₂ norm of the velocity residual decreases versus iteration number. Using the fixed-point i teration, o ne i teration c an already r each a small residual number (around 10⁻²), while adding one more iteration would increase the total computation cost by 20% due to the expensive deformation gradient projection within each iteration. Hence, one iteration may be used to balance accuracy and efficiency.

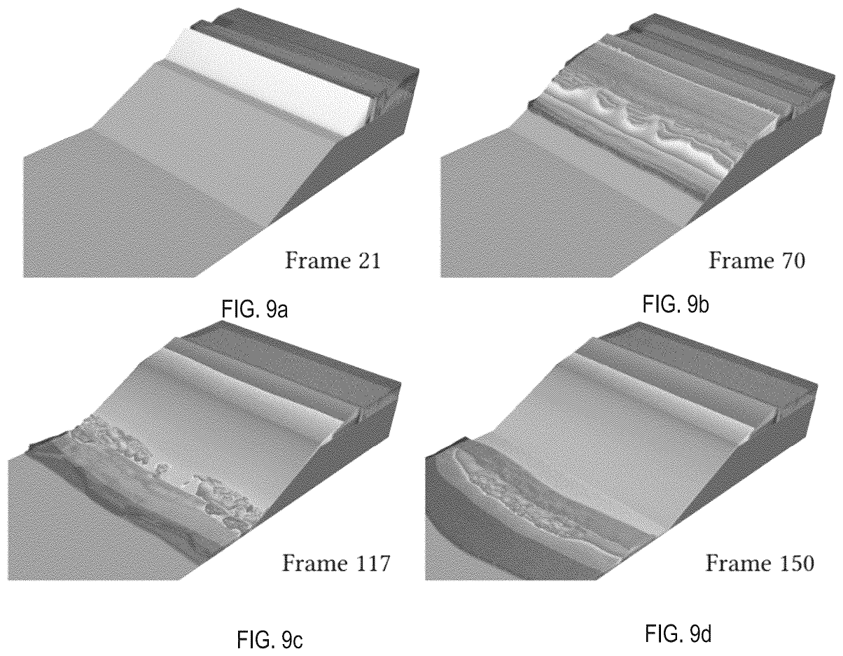

FIG. 9 shows the water from the right inlet slowly erodes the dam as simulated, where the sand transits from dry to wet as water saturation increases. When water seeps into the sand, the cohesion increases and then quickly decreases when reaching the capillary state. So, the dam eventually breaks due to internal seepage erosion, and the landslide creates interesting textures in the debris flow.

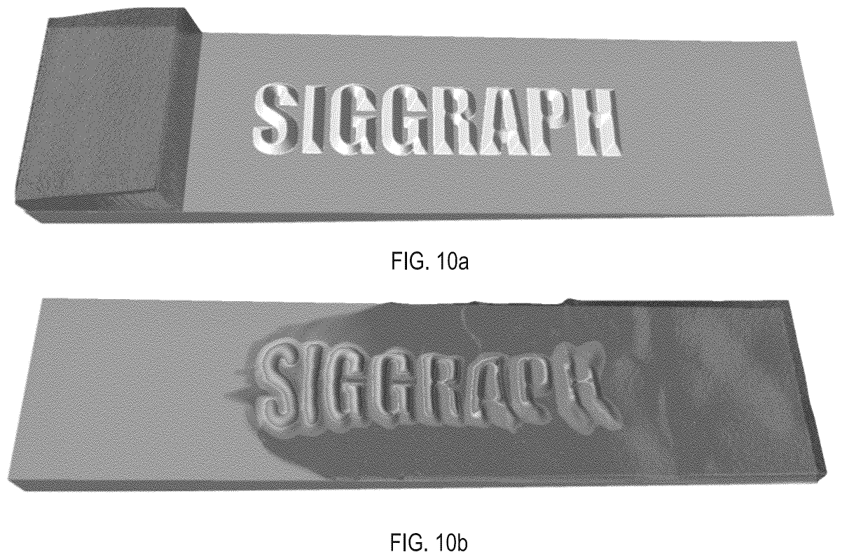

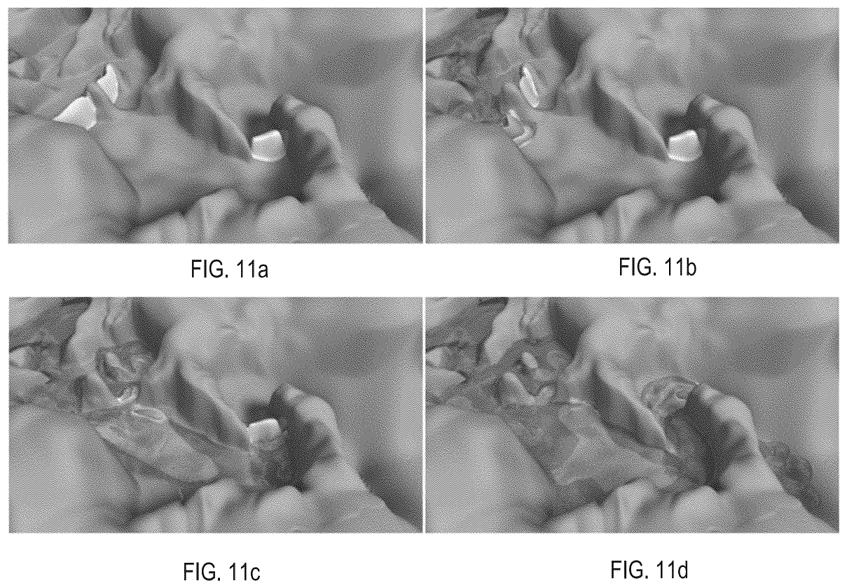

FIG. 10 shows a slope with “SIGGRAPH” letters made by sands, which are later washed away by the water, as simulated according to the method above. FIG. 11 further demonstrates an example of three sand dams in the canyon flushed by the flow, in which s and, water, and terrain are all represented as the height map. The real-time frame rate achieved using the method above allows for editing the height map interactively.

The method above can be easily parallelized on a GPU and achieve a real-time frame rate. Table 1 lists various parameters used in the simulations above. Table 2 provides the percentage of the simulation times used for different operations as well as the total computation time per step for scenes tested in the paper. T indicates how many sand updates are followed by one water update step. Over 70% of the simulation time is spent on two operations: deformation gradient projection and boundary conditions update. The deformation gradient update takes multiple CUDA kernel passes to first extrapolate the deformation gradient and velocity at the boundary faces and centers, then perform matrix SVD decomposition, and finally update and project deformation gradient matrices. Boundary condition update happens before almost every operation to determine the boundary type so the following kernels can process them accordingly.

TABLE 1
List of the main parameters used in the simulations

| | | | | | Dam | Dam | | |
|---|---|---|---|---|---|---|---|---|
| | Castle | | | Spring | break | breach | Beach | Canyon |
| | FIG. | | | | | | | |
| | 5a | 5b | 5c | 7a-7d | 6 | 9a-9d | 10a-10b | 11a-11d |
| E(×10⁴) | NA | NA | 8.0 | 8.0 | 8.0 | 8.0 | 6.0 | 8.0 |
| v | NA | NA | 0.3 | 0.3 | 0.3 | 0.3 | 0.3 | 0.3 |
| c₀ | NA | NA | 0.4 | 0.0 | 0.4 | 0.0 | 0.0 | 0.6 |
| c₁ | NA | NA | 0.9 | 0.9 | 0.9 | 0.045 | 0.54 | 0.9 |
| c₂ | NA | NA | 1.0 | 1.0 | 1.0 | 0.05 | 0.6 | 1.0 |
| μ | 0.5 | 100.0 | 0.5 | 0.5 | 0.5 | 0.6 | 0.5 | 0.8 |
| c_{E}/ρ^{w̅} | 2.0 | 2.0 | 2.0 | 0.1 | 0.5 | 0.1 | 5.0 | 2.0 |

TABLE 2
Performance breakdown

| | | Castle | Spring | Dam Break | Dam Breach | Flush | Canyon |
|---|---|---|---|---|---|---|---|
| Resolution | $\frac{x}{y}$ | 512 1024 | 1024 1024 | 512 512 | 512 1024 | 185 739 | 1024 1024 |
| Time step size (s) | | 0.003 | 0.012 | 0.045 | 0.015 | 0.027 | 0.015 |
| Async coefficient T | | 1 | 3 | 3 | 1 | 3 | 1 |
| Diffuse and integrate water | | 2.3% | 1.7% | 1.7% | 3.9% | 1.9% | 9.3% |
| Integrate water velocity | | 2.7% | 1.3% | 2.2% | 3.6% | 2.0% | 7.0% |
| Integrate sand height | | 4.2% | 4.0% | 3.4% | 2.8% | 4.4% | 7.0% |
| Integrate sand velocity | | 6.6% | 4.6% | 6.7% | 4.7% | 8.9% | 4.7% |
| Project deformation gradient | | 21.4% | 47.5% | 36.8% | 37.9% | 38.9% | 21.1% |
| Evolve deformation gradient | | 4.0% | 5.6% | 9.1% | 5.9% | 9.0% | 2.1% |
| Compute momentum exchange | | 5.0% | 9.8% | 8.4% | 5.7% | 9.4% | 3.1% |
| Apply frictional force | | 1.7% | 3.0% | 3.2% | 2.2% | 3.5% | 0.9% |
| Update boundary conditions | | 52.2% | 22.6% | 28.4% | 33.3% | 22.0% | 44.6% |
| Avg. time per step (ms) | | 0.30 | 2.33 | 0.42 | 0.37 | 0.33 | 0.60 |

To summarize, an example real-time simulation framework for a fluid and granular substance mixture is described above in detail. Such a framework may be based on modeling height fields and horizontal velocities of different material phases, which in the context of a water-sand system, may include sand, water, and mixed water. The framework achieves a trade-off between simulation fidelity and performance, providing real-time computation for interactive applications. The example framework formulates the external frictional force and elastoplastic internal force of sand based on horizontal grid and further handles the water/sand coupling via diffusion and momentum exchange. The time updates for the simulation is efficiently performed using a semi-implicit operator splitting discretization scheme and an asynchronous scheme for the fluid and the granular substance.

### Hardware Platform

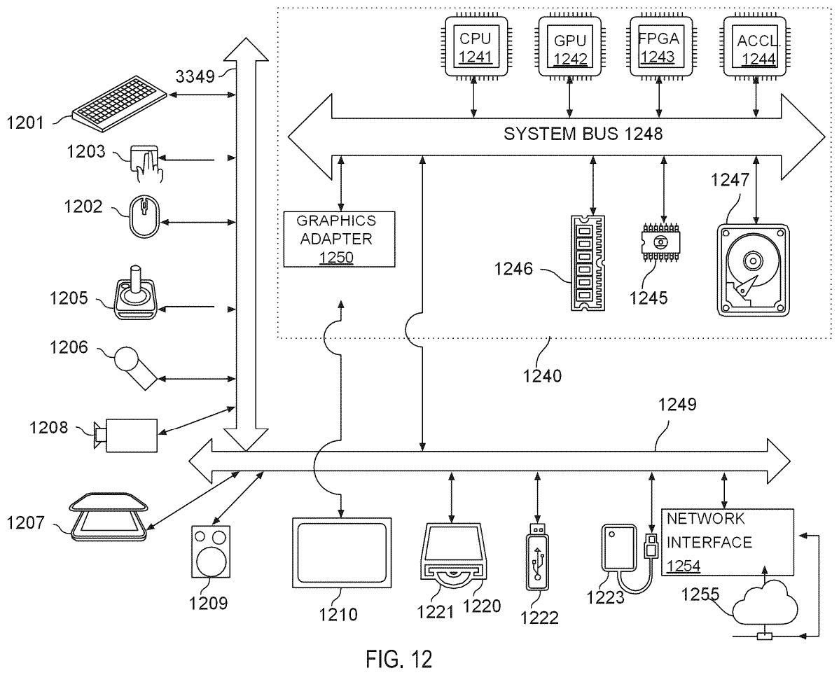

The techniques described above, may be implemented using specifically designed processors and memories in any electronic devices or may be implemented as computer software or firmware using computer-readable instructions and physically stored in one or more computer-readable media. For example, FIG. 12 shows a computer system (1200) suitable for implementing the embodiments of the disclosed subject matter.

The computer software or firmware can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), FPGAs, dedicated processing units, and the like.

The instructions can be executed on various types of computers or components thereof, including, for example, personal computers, tablet computers, servers, smartphones, gaming devices, internet of things devices, and the like.

The components shown in FIG. 12 for computer system (1200) are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system (1200).

Computer system (1200) may include input interface devices. Such a input interface device may be responsive to input by one or more users through, for example, tactile input (such as: keystrokes, swipes, data glove movements), audio input (such as: voice, clapping), visual input (such as: gestures), olfactory input (not depicted). The input interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video). The input interfaces may be used to input parameters and commands for the sand-water simulations above or for interactively controlling various graphics generated based on the sand-water simulations above.

The input interface devices may include one or more of (only one of each depicted): keyboard (1201), mouse (1202), trackpad (1203), touch screen (1210), data-glove (not shown), joystick (1205), microphone (1206), scanner (1207), camera (1208).

Computer system (1200) may also include certain output interface devices. Such output interface devices may be configured to stimulate senses of users through, for example, tactile output, sound, light, touch, smell/taste, and the like. Such output interface devices may include tactile input and output combination devices (for example tactile feedback by the touch-screen (1210), data-glove (not shown), or joystick (1205), but there can also be tactile feedback devices that do not serve as input devices), audio output devices (such as: speakers (1209), headphones (not depicted)), visual output devices (such as display screens (1210) including but not limited include CRT display screens, LCD display screens, plasma display screens, OLED screens, and projection displays, each with or without touch-screen input capability, each with or without tactile feedback capability-some of which may be capable to output two dimensional visual output or three-dimensional output through means such as stereoscopic graphic output; virtual-reality glasses (not depicted), holographic displays and smoke tanks (not depicted)). The output interface devices may include other devices such as two-dimensional or three-dimensional printers (not depicted).

Computer system (1200) can also include non-transitory storage devices and their associated media such as optical media including CD/DVD ROM/RW (1220) with CD/DVD or the like media (1221), thumb-drive (1222), removable hard drive or solid state drive (1223), legacy magnetic media such as tape and floppy disc (not depicted), specialized ROM/ASIC/PLD based devices such as security dongles (not depicted), and the like. Those skilled in the art should also understand that term “computer readable media” as used in connection with the presently disclosed subject matter does not encompass transmission media, carrier waves, or other transitory signals.

Computer system (1200) can also include an interface (1254) to one or more communication networks (1255). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G/LTE, 5G networks and the like, TV wireline or wireless wide area digital networks to include cable TV, satellite TV, and terrestrial broadcast TV, vehicular and industrial to include CAN bus, and so forth. The computer system (1200) may be connected to various external networks via network interface adapters that attached to general-purpose data ports or peripheral buses (1249) (such as, for example, USB ports) of the computer system (1200)). The network interfaces may alternatively be integrated into the core of the computer system (1200) by via system buss as described below (for example, Ethernet interface or cellular communication interface may be integrated into a PC computer system or smartphone computer system). Using any of these communication networks, the computer system (1200) can communicate with other remote electronic devices. Such communication can be uni-directional (e.g., receive-only (for example, broadcast TV), or transmit-only (for example CANbus to certain CANbus devices) or bi-directional (for example, both receive from and transmit information to other computer systems using local or wide area digital networks). A collection of protocols and protocol stacks can be used on each of those networks and network interfaces to effectuate network communications.

Aforementioned input and output interface devices, storage devices, and network interfaces can be attached to a core (1240) of the computer system (1200).

The core (1240) can include one or more Central Processing Units (CPU) (1241), Graphics Processing Units (GPU) (1242), specialized programmable processing units in the form of Field Programmable Gate Areas (FPGA) (1243), hardware accelerators for certain tasks (1244), graphics adapters (1250), and the like. These devices, along with Read-only memory (ROM) (1245), Random-access memory (1246), internal mass storage such as internal non-user accessible hard drives, SSDs, and the like (1247), may be connected through a system bus (1248). In some computer systems, the system bus (1248) can be accessible in the form of one or more physical connectors to enable extensions by additional CPUs, GPU, and the like. The peripheral devices can be attached either directly to the core's system bus (1248), or through a peripheral data bus (1249). In an example, the display screen (1210) can be connected to the graphics adapter (1250). Architectures for a peripheral bus may include but is not limited to PCI, USB, and the like. The CPUs (1241), GPUs (1242), FPGAs (1243), and accelerators (1244) can execute computer instructions as the aforementioned computer code. Such computer code can be stored in the ROM (1245) or RAM (1246). Intermediate processing data can also be stored in RAM (1246), whereas permanent data can be stored for example, in the internal mass storage (1247). Fast storage to and retrieval from any of the memory devices can be enabled through the use of cache memory. The cache memory may be integrated with or otherwise in direct communication with the one or more CPU (1241), GPU (1242), mass storage (1247), ROM (1245), RAM (1246), and the like.

The computer readable media may be configured to store computer code thereon for performing various computer-implemented operations. The media and computer code can be those specially designed and constructed for the purposes of the present disclosure, or they can be of general purpose.

As a non-limiting example, the computer system having architecture (1200), and specifically the core (1240) can provide functionality as a result of the processor(s) (including CPUs, GPUs, FPGA, accelerators, and the like) executing software embodied in one or more tangible, computer-readable media. Such computer-readable media can be implemented as the mass storage as described above, as well as certain storage of the core (1240) that are of non-transitory nature, such as core-internal mass storage (1247) or ROM (1245). The software for implementing the various embodiments of the present disclosure can be stored in such devices and executed by the computer core (1240). A computer-readable medium can include one or more memory devices or storage chips. The software can be executed to cause the computer core (1240) and specifically the processors therein (including CPU, GPU, FPGA, and the like) to execute particular processes or particular parts of particular processes described herein, including defining data structures stored in RAM (1246) and modifying such data structures according to the processes defined by the software. In addition or as an alternative, the computer system (1200) can provide functionality as a result of logic hardwired or otherwise embodied in a circuit (for example: accelerator (1244)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) for storing software for execution, a circuit embodying logic for execution, or both, where appropriate. The present disclosure encompasses any suitable combination of hardware and software.

In general, terminology may be understood at least in part from usage in its context. For example, terms, such as ‘and’, ‘or’, or ‘and/or,’ as used herein may include a variety of meanings that may depend at least in part upon the context in which such terms are used. Typically, the term ‘or’, if used to associate a list, such as A, B or C, is intended to mean A, B, and C, here used in the inclusive sense, as well as A, B or C, here used in the exclusive sense. In addition, the term ‘one or more’ or ‘at least one’ as used herein, depending at least in part upon context, may be used to describe any feature, structure, or characteristic in a singular sense or may be used to describe combinations of features, structures or characteristics in a plural sense. Similarly, terms, such as ‘a’, ‘an’, or ‘the’, again, may be understood to convey a singular usage or to convey a plural usage, depending at least in part upon context. In addition, the term ‘based on’ or ‘determined by’ may be understood as not necessarily intended to convey an exclusive set of factors and may, instead, allow for the existence of additional factors not necessarily expressly described, again, depending at least in part on context.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed:

1. A method for computer generation of a time evolution of horizontal height fields involving a fluid substance and a granular substance, comprising:
dividing the horizontal height fields at each horizontal cell of a plurality of horizontal cells over a predefined static terrain into one or more of a fluid layer of the fluid substance, a mixed layer of a mixture of the fluid substance and the granular substance, and a solid layer of the granular substance;
modeling the time evolution of at least one set of a first depth and a first horizontal velocity of the fluid layer, a second depth and a second horizontal velocity of the fluid substance in the mixed layer, and a third depth and a third horizontal velocity of the granular substance in each horizontal cell under a shallow-fluid approximation, using a plurality of mass and momentum conservation operators, in a plurality of sequential time steps, and adopting a splitting discretization scheme with respect to the plurality of mass and momentum conservation operators, the first depth, the second depth, and the third depth forming the horizontal height fields; and
generating a visual representation of the time evolution of at least one of the horizontal height fields, the first horizontal velocity, the second horizontal velocity, and the third horizontal velocity for display on a graphical user interface.

2. The method of claim 1, wherein modeling the time evolution of at least one set of the first depth and the first horizontal velocity, the second depth and the second horizontal velocity, and the third depth and the third horizontal velocity in each horizontal cell comprises:
modeling the first depth and the first horizontal velocity of the fluid layer in each horizontal cell with a first set of dynamic equations based on a continuity operator and a first momentum exchange force operator;
modeling the second depth and the second horizontal velocity of the fluid substance in the mixed layer in each horizontal cell with a second set of dynamic equations based on the continuity operator, a diffusion mass transfer operator, a gravity force operator, a diffusion force operator, and a second momentum exchange force operator;
modeling the third depth and the third horizontal velocity of the granular substance with a third set of dynamic equations based on the continuity operator, the gravity force operator, an elastoplastic force operator, a third momentum exchange force operator, and a friction force operator due to the predefined static terrain; and
generating the time evolution of at least one set of the first depth and the first horizontal velocity, the second depth and the second horizontal velocity, and the third depth and the third horizontal velocity at each of the plurality of sequential time steps based on the first set of dynamic equations, the second set of dynamic equations, and the third set of dynamic equations, using the splitting discretization scheme with respect to at least two of the continuity operator, the diffusion mass transfer operator, the gravity force operator, the diffusion force operator, the momentum exchange force operators, the elastoplastic force operator, and the friction force operator at each sequential time step.

3. The method of claim 2, wherein the continuity operator is applied to dynamically model the first depth, the second depth, and the third depth and configured to account for mass change due to horizontal flows of the fluid substance in the fluid layer, the fluid substance in the mixed layer, and the granular substance, respectively.

4. The method of claim 3, wherein the gravity force operator is applied to dynamically model the first horizontal velocity, the second horizontal velocity, and the third horizontal velocity to account to horizontal force component of gravity on each of the fluid layer, the fluid substance in the mixed layer, and the granular substance.

5. The method of claim 4, wherein the first moment exchange force operator is applied to dynamically model the first horizontal velocity of the fluid substance in the fluid layer and is configured to account for a first momentum exchange to the fluid substances in the fluid layer of a current horizontal cell from the mixed layer in neighboring horizontal cells.

6. The method of claim 4, wherein the diffusion mass transfer operator is applied to dynamically model the second depth in the mixed layer to account for a diffusion of the fluid substance relative to the granular substance in the mixed layer.

7. The method of claim 6, wherein the diffusion force operator is applied to dynamically model the second horizontal velocity of the fluid substance in the mixed layer to account for a diffusive force resulting from the fluid substance diffusing relative to the granular substance in the mixed layer.

8. The method of claim 7, wherein the second moment exchange force operator is applied to dynamically model the second horizontal velocity of the fluid substance in the mixed layer to account for a second momentum exchange to the fluid substances in the mixed layer of a current horizontal cell from a combination of the fluid substance in the fluid layer and the granular substance in the mixed layer and the solid layer in neighboring horizontal cells.

9. The method of claim 4, wherein the elastoplastic force operator is applied to dynamically model the third horizontal velocity of the granular substance in the mixed layer, and is derived from a stress in the granular substance depending on a deformation gradient and an elastic energy density in the granular substance.

10. The method of claim 9, wherein the stress is configured as being limited according to a cohesion between grains of the granular substance.

11. The method of claim 10, wherein the cohesion between grains of the granular substance is modeled as a piecewise function of a saturation level of the fluid substance mixed with the granular substance.

12. The method of claim 9, wherein the third moment exchange force operator is applied to dynamically model the third horizontal velocity of the granular substance to account for a third momentum exchange to the granular substance in the mixed layer and the solid layer of a current horizontal cell from the mixed layer in neighboring horizontal cells.

13. The method of claim 9, wherein the friction force operator is applied to dynamically model the third horizontal velocity of the granular substance to account for a frictional drag of the predefined static terrain on the granular substance.

14. The method of claim 2, wherein the splitting discretization scheme at each time step for updating the first depth, the first horizontal velocity, the second depth, and the second horizontal velocity comprises sequentially performing:
updating the first depth and the first horizontal velocity using the first set of dynamic equations and accounting only for the diffusion mass transfer operator and the diffusion force operator;
integrating the first depth and the second depth respectively using the first set of dynamic equations and the second set of dynamic equations, and accounting only for the continuity operator; and
integrating the first horizontal velocity and the second horizontal velocity respectively using the first set of dynamic equations and the second set of dynamic equations, and accounting only for the gravity force operator and the second momentum exchange force operator.

15. The method of claim 14, wherein the splitting discretization scheme at each of the plurality of sequential time steps for updating the third depth and the third horizontal velocity comprises iteratively performing the following in one or more sub time steps:
updating the third depth using the third set of dynamic equations and accounting only for the continuity operator;
performing a deformation gradient evolution of the third horizontal velocity using the third set of dynamic equations and accounting only for the elastoplastic force operator;
integrating the third horizontal velocity using the third set of dynamic equations and accounting only for the gravity force operator and the third momentum exchange force operator;
updating the third horizontal velocity using the third set of dynamic equations accounting only for the friction force operator; and
integrating the first horizontal velocity and the second horizontal velocity using the first set of dynamic equations and the second set of dynamic equations accounting only for the gravity force operator and the second momentum exchange force operator.

16. The method of claim 1, wherein the splitting discretization scheme comprises updating the time evolution of the fluid substance and the granular substance asynchronously with the time evolution for the granular substance updated more frequently.

17. A device for generation of a time evolution of horizontal height fields involving a fluid substance and a granular substance, the device comprising a memory for storing computer instructions and a processor for executing the computer instructions to:
divide the horizontal height fields at each horizontal cell of a plurality of horizontal cells over a predefined static terrain into one or more of a fluid layer of the fluid substance, a mixed layer of a mixture of the fluid substance and the granular substance, and a solid layer of the granular substance;
model the time evolution of at least one set of a first depth and a first horizontal velocity of the fluid layer, a second depth and a second horizontal velocity of the fluid substance in the mixed layer, and a third depth and a third horizontal velocity of the granular substance in each horizontal cell under a shallow-fluid approximation, using a plurality of mass and momentum conservation operators, in a plurality of sequential time steps, and adopting a splitting discretization scheme with respect to the plurality of mass and momentum conservation operators, the first depth, the second depth, and the third depth forming the horizontal height fields; and
generate a visual representation of the time evolution of at least one of the horizontal height fields, the first horizontal velocity, the second horizontal velocity, and the third horizontal velocity for display on a graphical user interface.

18. The device of claim 17, wherein to model the time evolution of the first depth, the first horizontal velocity, the second depth, the second horizontal velocity, the third depth, and the third horizontal velocity in each horizontal cell comprises to:
model the first depth and the first horizontal velocity of the fluid layer in each horizontal cell with a first set of dynamic equations based on a continuity operator and a first momentum exchange force operator;
model the second depth and the second horizontal velocity of the fluid substance in the mixed layer in each horizontal cell with a second set of dynamic equations based on the continuity operator, a diffusion mass transfer operator, a gravity force operator, a diffusion force operator, and a second momentum exchange force operator;
model the third depth and the third horizontal velocity of the granular substance with a third set of dynamic equations based on the continuity operator, the gravity force operator, an elastoplastic force operator, a third momentum exchange force operator, and a friction force operator due to the predefined static terrain; and
generate the time evolution of at least one set of the first depth and the first horizontal velocity, the second depth and the second horizontal velocity, and the third depth and the third horizontal velocity at each of the plurality of sequential time steps based on the first set of dynamic equations, the second set of dynamic equations, and the third set of dynamic equations, using the splitting discretization scheme with respect to at least two of the continuity operator, the diffusion mass transfer operator, the gravity force operator, the diffusion force operator, the momentum exchange force operators, the elastoplastic force operator, and the friction force operator at each sequential time step.

19. The device of claim 18, wherein the splitting discretization scheme at each time step for updating the first depth, the first horizontal velocity, the second depth, and the second horizontal velocity comprises the processor being configured to execute the computer instructions to:
update the first depth and the first horizontal velocity using the first set of dynamic equations and accounting only for the diffusion mass transfer operator and the diffusion force operator;
integrate the first depth and the second depth respectively using the first set of dynamic equations and the second set of dynamic equations, and accounting only for the continuity operator; and
integrate the first horizontal velocity and the second horizontal velocity respectively using the first set of dynamic equations and the second set of dynamic equations, and accounting only for the gravity force operator and the second momentum exchange force operator.

20. The device of claim 19, wherein the splitting discretization scheme at each of the plurality of sequential time steps for updating the third depth and the third horizontal velocity comprises the processor being configured to execute the computer instructions to, in an iterative manner in one or more sub time steps:
update the third depth using the third set of dynamic equations and accounting only for the continuity operator;
perform a deformation gradient evolution of the third horizontal velocity using the third set of dynamic equations and accounting only for the elastoplastic force operator;
integrate the third horizontal velocity using the third set of dynamic equations and accounting only for the gravity force operator and the third momentum exchange force operator;
update the third horizontal velocity using the third set of dynamic equations accounting only for the friction force operator; and
integrate the first horizontal velocity and the second horizontal velocity using the first set of dynamic equations and the second set of dynamic equations accounting only for the gravity force operator and the second momentum exchange force operator.
